(19) United States
(12) Patent Application Publication
(10) Pub. No.: US 2026/0012230 A1
(43) Pub. Date: Jan. 8, 2026

(54) PASSIVE MASSIVE MULTIPLE-INPUT MULTIPLE-OUTPUT TRANSMISSION APPROACH USING RECONFIGURABLE INTELLIGENT SURFACES

(71) Applicant: NEC Laboratories Europe GmbH, Heidelberg (DE)

(72) Inventors: Marco Rossanese, Heidelberg (DE); Francesco Devoti, Heidelberg (DE); Vincenzo Sciancalepore, Heidelberg (DE)

(21) Appl. No.: 19/258,942

(22) Filed: Jul. 3, 2025

(30) Foreign Application Priority Data
Jul. 4, 2024 (EP) 24186612

(51) Int. Cl. H04B 7/0413; H04B 7/04; H04B 7/06; H04L 25/02

(52) U.S. Cl. CPC H04B 7/0413; H04B 7/04026; H04B 7/06952; H04L 25/0202

(57) ABSTRACT

A computer-implemented method for mimicking a multi-user multiple-input multiple-output (MIMO) base station using a re-designed channel estimation procedure is provided. The method includes sweeping a set of beam patterns to obtain channel information associated with a plurality of pilot signals from a plurality of user equipment (UEs) and selecting a beam to communicate with each of the plurality of UEs. The method further includes allocating radio resources to communicate with each of the plurality of UEs based on the selected beam for each of the plurality of UEs and performing downlink and uplink transmissions to and from the plurality of UEs based on the allocated radio resources. In some instances, the method can include computational intelligence to allow for optimized and/or enhanced decision making based on using a reconfigurable intelligence surface (RIS) and a single radio-frequency (RF) chain to mimic the operation of multi-user MIMO base stations.

### CROSS REFERENCE TO RELATED APPLICATIONS

This application claims benefit to European Patent Application No. EP 24186612.8, filed on Jul. 4, 2024, which is hereby incorporated by reference herein.

### FIELD

The present disclosure relates to a passive massive multiple-input multiple output (MIMO) transmission approach using reconfigurable intelligence surfaces (RIS), and in particular to a method, system, data structure, computer program product and computer-readable medium for mimicking the operation of a multi-user MIMO base station (BS) unit with a single source and an RIS.

### BACKGROUND

Mobile network operators (MNO) can sustain significant costs to deploy, operate, and/or maintain their telecommunication systems. Some of the main costs, in terms of capital expenditures (CapEx) and operational expenses (OpEx), can be individuated in the purchase of the equipment for the BSs and for power to execute their routine operations (see e.g., Alfio Lombardo. 2019. Cost Analysis of Orchestrated 5G Networks for Broadcasting. EBU Tech Review (2019), which is incorporated by reference herein). These costs can be even higher if a MIMO BS is considered. For instance, a particular MIMO BS, such as the MB5460-m from the NIPPON ELECTRIC COMPANY (NEC), can include 192 antennas that are equipped with a significant computational power.

In general, a typical MIMO BS includes multiple antennas that can be connected, singularly or as subsets, to a radio frequency (RF)-chain. An RF chain can be a cascade of electronic components, such as amplifiers, filters, mixers, attenuators, and/or detectors, that are used to process the signals and finally emit them using the antenna. This building block can be fundamental for the operation of a BS and can also be one of the primary sources of costs due to its complexity and the significant power consumption utilized to keep it running. Moreover, MNOs have to account for other accessory costs for normal operations of a BS, such as cooling as well as site operation and maintenance. As such, in view of the above, the high CapEx and OpEx costs related to the employment of MIMO BSs can be a strong limiting factor of their employment in areas with a low population density and/or in developing countries that have few suitable areas eligible to install MIMO BS systems. This can be mainly due to the limited economic resources or foreseen economic revenues from the MNO.

### SUMMARY

In an embodiment, the present disclosure provides a computer-implemented method for mimicking a multi-user multiple-input multiple-output (MIMO) base station using a re-designed channel estimation procedure. The method includes sweeping a set of beam patterns to obtain channel information associated with a plurality of pilot signals from a plurality of user equipment (UEs) based on exploiting directionality and based on the channel information, selecting a beam to communicate with each of the plurality of UEs. The method further includes allocating radio resources to communicate with each of the plurality of UEs based on the selected beam for each of the plurality of UEs and performing downlink and uplink transmissions to and from the plurality of UEs based on the allocated radio resources. In some instances, the method can include computational intelligence to allow for optimized and/or enhanced decision making based on using a reconfigurable intelligence surface (RIS) and a single radio-frequency (RF) chain to mimic the operation of multi-user MIMO base stations. For instance, embodiments of the present disclosure can achieve optimized and/or enhanced decision making based on using the RIS and the single RF to facilitate communications between the MIMO base station and the UEs.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 shows a frame structure of MIMO transmissions;

FIG. 2 illustrates a diagram comprising a single RIS system for mimicking MIMO operations according to one or more embodiments of the present disclosure;

FIGS. 3A-3D show an example of operations for servicing a plurality of UEs according to one or more embodiments of the present disclosure;

FIGS. 4A and 4B show frame structures for the single RIS system according to one or more embodiment of the present disclosure;

FIG. 5 illustrates a diagram comprising a single transmissive RIS (T-RIS) system for mimicking MIMO operations according to one or more embodiments of the present disclosure;

FIG. 6 illustrates a three dimensional (3D) and two dimensional (2D) representation of a multiple T-RIS system for mimicking MIMO operations according to one or more embodiments of the present disclosure;

FIG. 7 illustrates a radio frequency (RF)-circuit and antenna array-based system according to one or more embodiments of the present disclosure; and

FIG. 8 is a block diagram of an exemplary processing system, which can be configured to perform any and all operations disclosed herein.

### DETAILED DESCRIPTION

As will be described in further detail below, embodiments of the present disclosure mimic the operation of a multi-user MIMO BS unit with a single source and an RIS. For instance, a standard MIMO BS can include several antennas and/or RF chains, which can be a cascade of electronic components that are used to process the signal. This can create a complex and power-hungry system. Instead of using a standard MIMO BS, in some examples, embodiments of the present disclosure can use of a single RF chain for the signal source emitted from a single antenna steering the beam towards the RIS, which can reflect efficiently to the user or to a selected area with limited power consumption and efficient power distribution.

In some instances, embodiments of the present disclosure can include and/or utilize a method to mimic the operation of multi-user MIMO base stations with the aid of an RIS and a single RF-chain antenna. Additionally, and/or alternatively, the method can be used to directionally sense pilots from the user equipment (UEs) to obtain spatially orthogonal samples of the channel and combine them to perform MIMO channel estimation with a single RF-chain and an RIS. Additionally, and/or alternatively, the method can be used for mimicking the multi-user MIMO transmission frame by grouping multiple UEs in the same directional transmission and allocating time-frequency resources in a time space division multiple access fashion with a single RF-chain.

Thus, based on using embodiments of the present disclosure, numerous technical advantages can be achieved such as allowing for full integration to standardized systems. For instance, embodiments of the present disclosure can be added to existing networks easily and with limited financial investments. Additionally, and/or alternatively, embodiments of the present disclosure can employ hardware with a lower complexity compared to the traditional MIMO technology. For instance, embodiments of the present disclosure can reduce the number of RF-chains to a single RF-chain and/or require no RF circuits to bring the signal to all of the antenna elements. To put it another way, embodiments of the present disclosure can utilize less hardware elements than traditional technology (e.g., MIMO technology) while achieving the same and/or better results than traditional technology. As such, by using lower complexity hardware elements, this can allow the MNO to reduce their financial obligations, which enables deployment in lower population density and/or in developing countries.

According to a first aspect, the present disclosure provides a computer-implemented method for mimicking a multi-user multiple-input multiple-output (MIMO) base station using a re-designed channel estimation procedure. The method comprises sweeping a set of beam patterns to obtain channel information associated with a plurality of pilot signals from a plurality of user equipment (UEs) based on exploiting directionality; based on the channel information, selecting a beam to communicate with each of the plurality of UEs; allocating radio resources to communicate with each of the plurality of UEs based on the selected beam for each of the plurality of UEs; and performing downlink and uplink transmissions to and from the plurality of UEs based on the allocated radio resources.

According to a second aspect, the method according to the first aspect further comprise setting a base station (BS) to receive the plurality of pilot signals from the plurality of UEs; and based on the selected beam for each of the plurality of UEs, grouping the plurality of UEs into one or more groups such that each of the one or more groups are covered by the same selected beam, wherein allocating the radio sources and performing the downlink and uplink transmissions are based on the grouping.

According to a third aspect, the method according to any of the first or the second aspect further comprises that sweeping the set of beam patterns comprises sweeping the set of beam patterns using a single radio-frequency (RF) chain and a reconfigurable intelligence surface (RIS).

According to a fourth aspect, the method according to any of the first to third aspects further comprises positioning an antenna in range of the RIS to focus a transmission/reception to/from a surface of the RIS; connecting the antenna with the RF chain to one or more hardware elements; and defining a set of orthogonal RIS configurations that are suitable for performing directional channel sounding.

According to a fifth aspect, the method according to any of the first to fourth aspects further comprises that sweeping the set of beam patterns using the single RF chain and the RIS comprises: sweeping the set of beam patterns to obtain a plurality of channel conditions for a UE from the plurality of UEs, wherein each beam pattern from the set of beam patterns is associated with an azimuth angle and an elevation angle, and wherein each of the plurality of channel conditions is associated with a beam pattern from the set of beam patterns; and obtaining the channel information for the UE based on the plurality of channel conditions.

According to a sixth aspect, the method according to any of the first to fifth aspects further comprises that selecting a beam to communicate with each of the plurality of UEs comprises: determining a channel condition from the plurality of channel conditions based on comparing absolute values of the plurality of channel conditions; selecting an azimuth angle and an elevation angle associated with the determined channel condition; and selecting the beam to communicate with the UE based on the selected azimuth angle and the selected elevation angle.

According to a seventh aspect, the method according to any of the first to sixth aspects further comprises that selecting the beam to communicate with the UE based on the selected azimuth angle and the selected elevation angle comprises: selecting the beam based on using a first codebook that was used for sweeping the set of beam patterns, using a second codebook comprising precomputed multi-beam configurations, or generating new beamforming configurations for the RIS.

According to an eighth aspect, the method according to any of the first to seventh aspects further comprises grouping the UE into a first group of a plurality of groups based on the selected azimuth angle and the selected elevation angle, wherein the first group comprises a subset of the plurality of UEs that all have the same selected azimuth angle and the same selected elevation angle, and wherein allocating the radio resources comprises allocating a first resource block for the first group, and wherein the downlink and uplink transmissions for the first group are performed in the first resource block.

According to a ninth aspect, the method according to any of the first through eighth aspects further comprises that sweeping the set of beam patterns comprises sweeping the set of beam patterns using a system comprising a single radio-frequency (RF) chain and one or more transmissive reconfigurable intelligence surfaces (T-RIS).

According to a tenth aspect, the method according to any of the first through ninth aspects further comprises that sweeping the set of beam patterns using the single RF chain and the one or more T-RIS comprises: sweeping a series of unique single-beam configurations to obtain the channel information comprising received powers from the plurality of UEs; and determining positions of the plurality of UEs based on the received powers, and wherein selecting the beam to communicate with each of the plurality of UEs is based on the determined positions.

According to an eleventh aspect, the method according to any of the first through tenth aspects further comprises that the system comprises a single omnidirectional antenna and three T-RIS that form an exterior of the system, and wherein the single omnidirectional antenna is positioned within an interior formed by the three T-RIS such that the system provides 360° power coverage.

According to a twelfth aspect, the method according to any of the first through eleventh aspects further comprises that sweeping the set of beam patterns comprises sweeping the set of beam patterns using a radio frequency (RF) circuit and antenna array-based system comprising an RF chain, an N-way power splitter, coaxial cables, a phase shifters bank, and an antenna array.

According to a thirteenth aspect, the method according to any of the first through twelfth aspects further comprises that a signal from/to the RF chain reaches the phase shifters bank and the antenna array through the N-way power splitter, and wherein the N-way power splitter is an N-way power divider/combiner.

According to a fourteenth aspect, a computer system is provided for mimicking a multi-user multiple-input multiple-output (MIMO) base station using a re-designed channel estimation procedure, the computer system comprising one or more hardware processors, which, alone or in combination, are configured to provide for execution of the following steps: sweeping a set of beam patterns to obtain channel information associated with a plurality of pilot signals from a plurality of user equipment (UEs) based on exploiting directionality; based on the channel information, selecting a beam to communicate with each of the plurality of UEs; allocating radio resources to communicate with each of the plurality of UEs based on the selected beam for each of the plurality of UEs; and performing downlink and uplink transmissions to and from the plurality of UEs based on the allocated radio resources.

A fifteenth aspect of the present disclosure provides a tangible, non-transitory computer-readable medium having instructions thereon, which, upon being executed by one or more processors, provides for execution of the method according to any of the first to the thirteenth aspects and/or the method comprising the following: sweeping a set of beam patterns to obtain channel information associated with a plurality of pilot signals from a plurality of user equipment (UEs) based on exploiting directionality; based on the channel information, selecting a beam to communicate with each of the plurality of UEs; allocating radio resources to communicate with each of the plurality of UEs based on the selected beam for each of the plurality of UEs; and performing downlink and uplink transmissions to and from the plurality of UEs based on the allocated radio resources.

Prior to describing embodiments of the present disclosure in more detail, the traditional MIMO BS and RIS are first described. For instance, a major advantage of MIMO technology is that it enables directional transmissions through beamforming to offer higher gain to connected users while minimizing interference. Indeed, the usage of antenna arrays comprising multiple antenna elements can generate one or several beams to channel the transmission power, e.g., focus the transmission, to the desired directions in a beam-shaped manner. Thanks to the availability of multiple RF-chains that are equipped to the MIMO BS, different beams can carry different data streams, e.g., they can be used to spatially multiplex the data transmissions. Therefore, this can increase the throughput and/or achieve high spatial diversity gain, hence obtaining higher resilience to errors. The number of independent data streams is limited by the number of RF-chains installed.

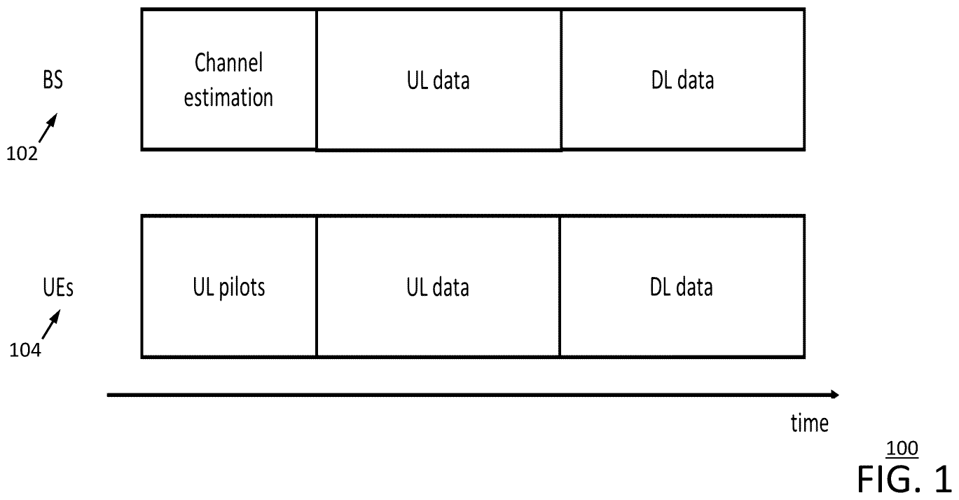

FIG. 1 shows a frame structure 100 of MIMO transmissions. For example, FIG. 1 shows the BS frame structure 102 and the UEs frame structure 104. The BS frame structure 102 includes the channel estimation, uplink (UL) data, and downlink (DL) data over a time range. The UEs frame structure 104 includes UL pilots, UL data, and DL data over the time range. For instance, as depicted, the multi-user MIMO communication protocol can be based on a frame structure 100 where UEs are transmitting pilots in UL while the BS is performing channel estimation. Pilots sent by the UEs are orthogonal to each other, allowing the BS to separate transmissions from different users and estimate the channel conditions for each of them. The channel estimation is required to properly configure the antenna array at the BS, namely setting the precoder and the combiner, to maximize the signal to interference and noise ratio (SINR) when transmitting/receiving data to/from the UEs. This procedure is followed by the transmission of UL and DL data from the UEs to the BS and from the BS to the UEs, respectively. Channel estimation and data transmission operations are repeated over time.

An RIS is a passive or almost-passive device (e.g., in terms of power consumption) that can reflect the incoming electromagnetic (EM) waves in a beamformed way. Usually, it includes a high number of antennas (or reflectors) connected to a phase shifter, where each antenna can re-emit the received signal with a phase delay and thus generate beamforming. Since no RF-chains or active RF components are involved here, this process can be referred to as passive beamforming.

As will be explained in further detail below, in some variations, embodiments of the present disclosure can describe an approach that mimics a multi-user MIMO BS by using a single antenna (e.g., a single directive antenna such as a horn antenna). Thus, this can mean that only one RF-chain is involved. Additionally, and/or alternatively, embodiments of the present disclosure can employ an RIS to provide the dynamic beamforming capabilities to the system.

In some examples, based on the RIS being correctly and/or properly configured and after illuminating the RIS with the source antenna, embodiments of the present disclosure can create one or more beams, which can be steered as desired. This can be similar to the functionality for the MIMO BS, but can drastically drop and/or reduce the complexity, the hardware costs, and/or the maintenance costs.

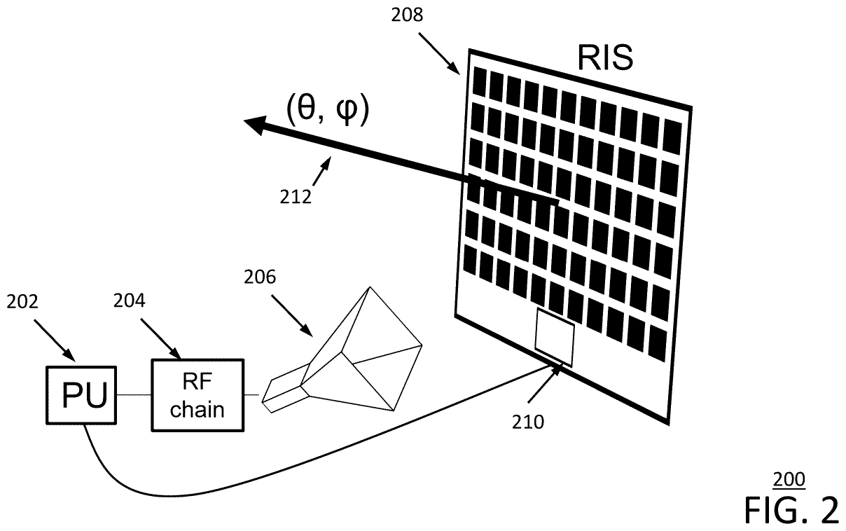

Embodiments of the present disclosure will be described in more detail below. For instance, in one or more first embodiments, a single antenna with a single RIS is described. In the first embodiments, the replication of a multi-user MIMO BS with an RIS can include a single transmitting/receiving antenna (e.g., a horn antenna) that is in close vicinity to one or more RIS. This is described in further detail in FIG. 2. For instance, FIG. 2 illustrates a diagram comprising a single RIS system 200 for mimicking MIMO operations according to one or more embodiments of the present disclosure. The system 200 includes a processing unit (PU) 202, an RF chain 204, a horn antenna 206, an RIS 208 with a microcontroller unit (MCU) 210, and a reflected signal 212 from the RIS 208.

The example from FIG. 2 depicts a horn antenna 206 that has the characteristic of transmitting/receiving the signal to/from a single direction. Hence the horn antenna 206 can: in transmission, focus the transmitted energy on the RIS surface of the RIS 208 to illuminate the RIS 208; in reception, receive the signal reflected from the RIS 208.

The transmitting/receiving antenna (e.g., the horn antenna 206) is positioned in such a way that it guarantees that each RIS element of the RIS 208 is well-illuminated by the signal. A PU 202 is connected to the transmitting source and the RIS 208. The task of the PU 202 is to: i) process the data stream and apply modulation and/or coding schemes; ii) select and/or set the configuration of the RIS 208; iii) perform channel estimation; iv) deliver the signal that is transmitted to the antenna 206; and vi) configure the RISs 208, e.g. the PU 202 is connected to the RIS controller, which in the example in FIG. 2 is the MCU 210 on the board of the RIS 208. The RIS configuration can be carried out with different techniques, for example using a codebook, e.g., a set of precomputed RIS configurations, or the configuration can be even generated in real time if the PU 202 is equipped with sufficient computational power. Note that this can allow for different beam forming techniques such as the ones requiring extreme near field to operate.

The setup shown in FIG. 2 (e.g., the system 200) can perform a channel estimation process to initialize the transmission. Channel estimation can be fundamental for the proper utilization of the system 200 and classical existing approaches cannot be straightforwardly applied to the system 200. A re-elaboration of them is an important step to make this setup recreate the MIMO operation successfully. As such, channel estimation will be initially described below.

For example, embodiments of the present disclosure can exploit the directionality of the RIS 208 and its fast reconfigurability to realize a beam sweep procedure to perform the channel estimation. In this way, embodiments of the present disclosure can iteratively perform the channel estimation procedure using a single-RF chain (e.g., the RF chain 204) while applying different RIS configurations. Different channel measurements are then combined and analyzed by the PU 202 to determine channel conditions in different directions and obtain the best RIS configuration for the RIS 208 for the data transmission.

For instance, during the channel estimation, a set of orthogonal beam configurations at the RIS 208 is selected, so that a set of spatially independent measures of the channel can be obtained. These measurements can then be collected and processed by the PU 202, that can project them on their MIMO equivalent. With this input, embodiments of the present disclosure can obtain the optimal RIS configuration for transmission.

In other words, focusing on a single UE, the received signal for the u-th UE can be seen as:

$${y}_{i} = {h}_{R}^{T} Θ {h}_{u} s + n$$

where h_{R}∈1×N is the channel between the antenna 206 and the RIS 208 and is known by definition as it is defined by the construction of the system 200, η∈N×N is a diagonal matrix containing the RIS configuration, and hᵤ∈N×1 is the channel between the RIS 208 and the UE, s is the signal and n is the noise

Embodiments of the present disclosure can denote

$${θ}_{RR , c} = {h}_{R}^{T} {Θ}_{c} ∈ 1 \times N$$

as the vector representing the joint effect of the antenna-RIS channel and the RIS configuration, with c denoting the c-th configuration of the RIS 208 used during the channel estimation. Considering a set of C=N orthogonal RIS configurations, the number of orthogonal configurations that can be created with N antennas (e.g., RIS elements of the RIS 208) is equal to N.

Embodiments of the present disclosure can sweep through the C configurations and collect directional samples of the channel, denoted as y_{i,c}.

Embodiments of the present disclosure can then construct the following equation:

$${y}_{i} = {Θ}_{RR} {h}_{i}$$

where the c-th element of the vector yᵢ∈N×1 is y_{i,c}, Θ_{RR}∈N×N is a matrix whose c-th row is

$${h}_{R}^{T} {Θ}_{c} ,$$

and again the desired channel is hᵢ

Embodiments of the present disclosure can then estimate the RIS-UE channel as

$$= {Θ}_{RR}^{- 1} {y}_{u} ∈ N \times 1 .$$

Given the orthogonality of pilots, this operation can be performed simultaneously for all the UEs. Estimations can be concatenated and the estimation of the MIMO channel Ĥ∈N×U can be obtained where each column of the matrix corresponding to the channel of the user u of Ĥ is [symbol] .

The orthogonality of the selected RIS configurations ensures that measurements are independent hence that all the MIMO channel components can be correctly estimated.

This approach can also provide other information, for example, the position with respect to the RIS 208. It can be noted that the knowledge of the relative position of the UE with respect to the RIS 208 can be used as an additional input to the channel estimation procedure as it can be directly used to compute the channel via suitable channel models (see e.g., Albanese, A., Devoti, F., Sciancalepore, V., Di Renzo, M., & Costa-Pérez, X. (2022 May). MARISA: A self-configuring metasurfaces absorption and reflection solution towards 6G. In IEEE INFOCOM 2022-IEEE Conference on Computer Communications (pp. 250-259). IEEE, which is incorporated by reference herein).

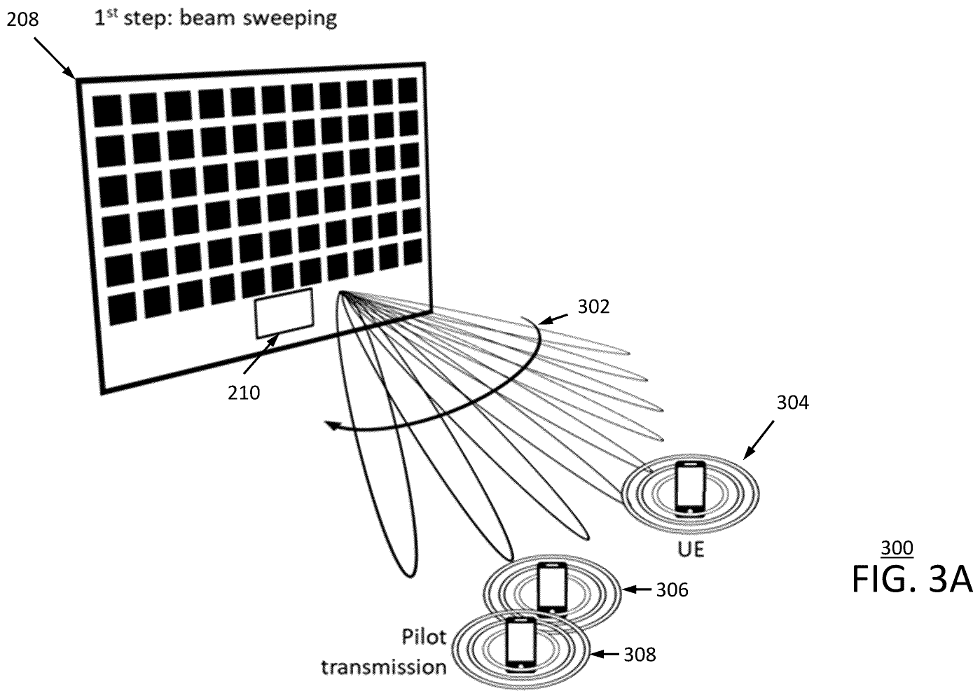

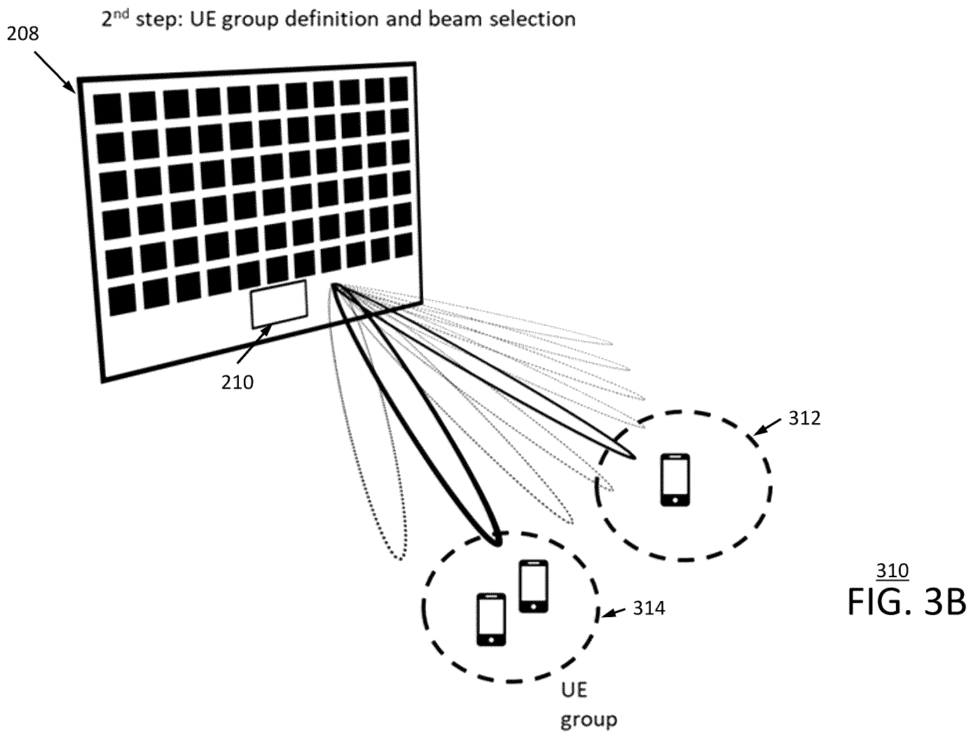

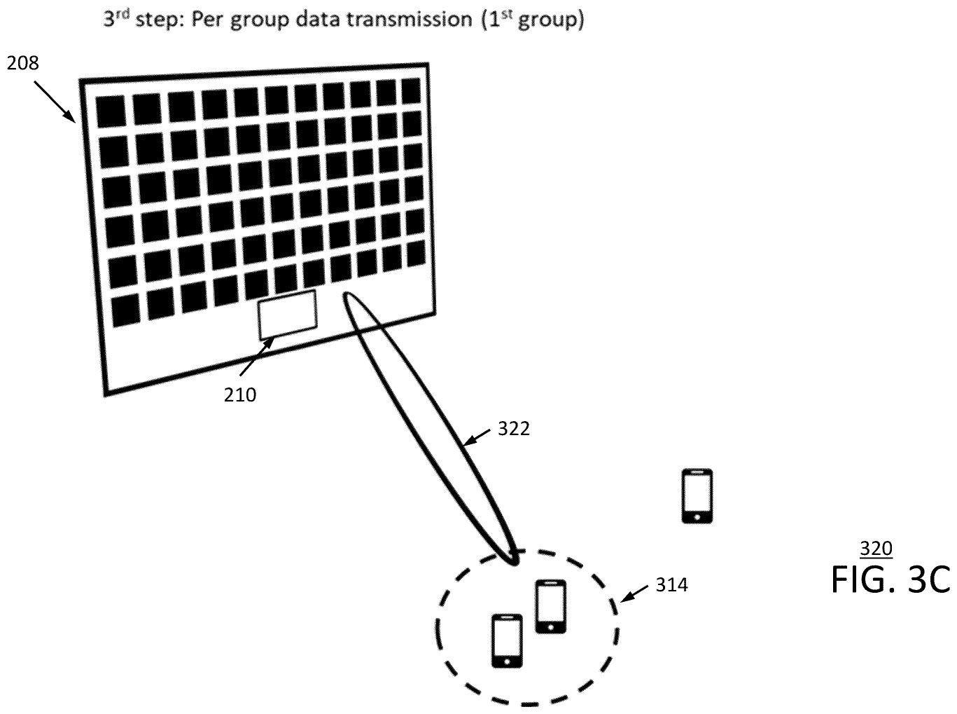

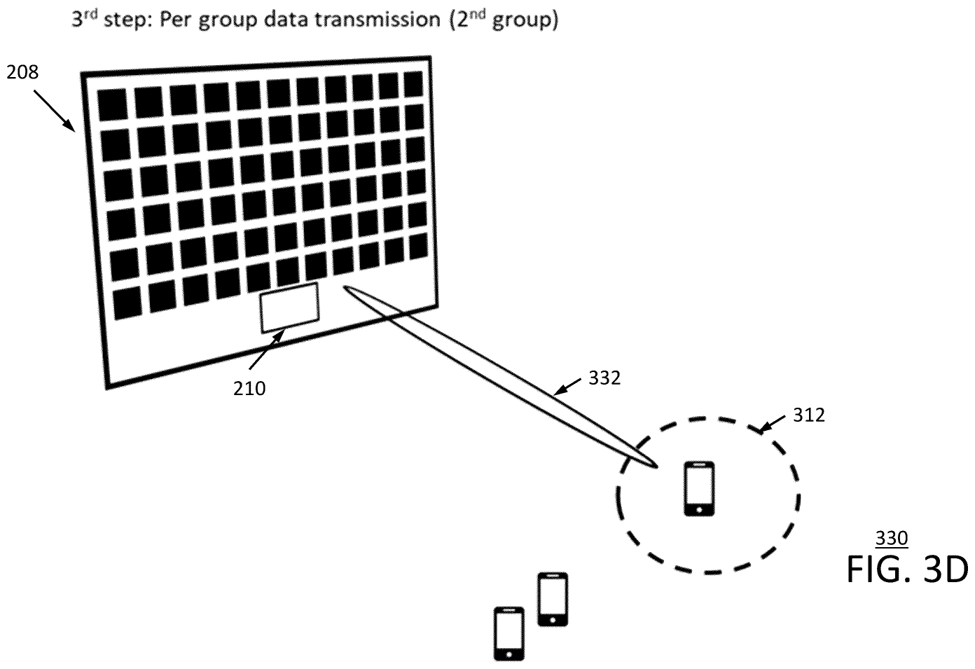

In other words, in some embodiments, the channel estimation can be described as follows: the RIS 208 is sweeping a series of unique single-beam configurations, in terms of azimuth, θ, and elevation, φ, angles, while the UEs are sending pilot signals as per standard MIMO procedure. Per each beam activation at the RIS 208, channel conditions h per each UE are measured. This information is stored in the PU 202 with the associated angles in the form (θ, φ, h). Given the high directivity of RIS 208, it is reasonable to assume that high channel gain, e.g., the absolute value of h, is obtained when the beam is oriented in the direction of the UE, this fact is even more remarked when millimeter (mm) Wave is assumed. Based on this, the PU 202 selects a set of beam configurations suitable for communicating with the UEs. This operation can be performed in the following not exhaustive approaches: i) by selecting the beams from the same codebook used for probing; ii) by looking at a second codebook with precomputed multi-beam configurations fulfilling the required pointing angles; and/or iii) by generating a new beamforming configuration at the RIS 208 on the spot. An example of the operations described above is provided in FIG. 3, which will be described below.

To put it another way, within a communication environment, the single RIS system 200 can attempt to communicate with one or more UEs (e.g., three UEs, which are shown in FIGS. 3A-3D). In a traditional MIMO set-up, multiple antenna arrays (e.g., multiple RF chains with multiple antennas) can be configured to generate and transmit beams that are directed to a plurality of different directions. However, this can make the traditional MIMO set-up more complex due to having to use multiple antenna arrays, especially the multiple RF chains, which are costly. In contrast, by using an RIS 208, embodiments of the present disclosure can utilize a single RF chain (e.g., the RF chain 204) and a single antenna (e.g., the horn antenna 206) to perform the functionality that previously utilized multiple antenna arrays. For example, the RIS 208 can include a plurality of RIS elements that are reconfigurable and the RIS system 200 can use the RIS elements to generate and transmit the beams that are directed to a plurality of different directions. As such, given that each of the plurality of RIS elements can be reconfigurable, a control unit (e.g., the MCU 210 and/or the PU 202) can reconfigure (e.g., move, rotate, and/or otherwise orient) the elements into being able to transmit signals to a plurality different directions (e.g., directions that can be defined based on an azimuth angle θ and an elevation angle φ) and/or receive signals from the plurality of different directions.

However, in order to utilize the RIS system 200 that includes only a single RF chain 204 and a single horn antenna 206, channel estimation is initially performed. For instance, the UEs can send pilot signals per standard MIMO procedure. Based on using the set of configurations, a control unit can reconfigure the elements of the RIS 208 (e.g., the elements can be oriented based on an azimuth angle θ and an elevation angle φ, which is described above). Per each beam activation, the channel conditions h for each UE can be obtained and/or measured (e.g., a channel condition can be obtained for each beam from the set of beam patterns). For instance, each beam activation can refer to a configuration of the RIS 208 (e.g., every possible state that the RIS 208 can be set). In other words, each configuration can correspond to a beam or multiple beams, and can be unique in terms of the direction of the beam(s), which can be expressed in azimuth angles θ and/or elevation angles φ. The mathematical expressions for the channel conditions h are described above. In the example above having three UEs, three channel conditions h can be obtained and/or measured per each beam activation. The PU 202 can obtain the channel conditions h from the RIS 208 via the horn antenna 206 and the RF chain 204. The PU 202 can store information indicating the channel conditions h along with its corresponding azimuth angle θ and elevation angle φ that were used to obtain the channel conditions h. Thus, for each UE, the PU 202 can store a plurality of channel conditions h along with their corresponding azimuth angles θ and elevation angles φ. Then, based on the high directivity of the RIS 208, the PU 202 can determine that the azimuth angle θ and the elevation angle φ associated with the highest channel gain would indicate the direction of the UE. For instance, the PU 202 can determine the directionality of the UE from the RIS 208 based on the azimuth angle and the elevation angle that has the greatest channel gain (e.g., the azimuth angle and elevation angle associated with the greatest absolute value of the channel condition h). Thus, based on determining and comparing the absolute values of the channel conditions h, the PU 202 can determine the azimuth angle and the elevation angle to use for communicating with each of the UEs. Following, based on the determined azimuth angle and the elevation angle, the PU 202 can select a set of beam configurations to communicate with the UEs. The selection can be based on selecting the beams from the same codebook used for probing, using a second codebook with precomputed multi-beam configurations fulfilling the required point angles, and/or generating a new beamforming configuration at the RIS 208 on the spot.

For instance, a first codebook (e.g., a codebook used for probing) can have only one beam per configuration and can be used to determine angular direction of the UEs. If only one UE is to be served, then embodiments of the present disclosure can use the one configuration from this codebook. In some instances, to server two or more UEs simultaneously, embodiments of the present disclosure can use a second codebook. For example, generating this type of configuration can be heavy, and so they can be precomputed and the IRS 208 has to select the best one that satisfies the angular directions of the UEs that it seeks to serve. In the third case (e.g., generating the new beamforming configurations on the spot), a configuration can be computed by the MCU 210 of the RIS 208 on the fly, and the configuration can include just one beam.

FIGS. 3A-3D show an example of operations for servicing a plurality of UEs according to one or more embodiments of the present disclosure. For instance, FIG. 3A shows a beam sweeping procedure during directional channel estimation while the UEs are transmitting pilot signals. FIG. 3B shows the grouping of UEs based on their channel condition and selection of beam forming configurations to serve them. FIGS. 3C and 3D show sequential data transmissions to the different groups of UEs.

For instance, referring to FIG. 3A, in a first step 300, the RIS 208 with its MCU 210 are shown. The beam sweeping procedure 302 is performed. Three UEs 304-308 are shown in FIG. 3A. The three UEs 304-308 perform pilot transmissions that are detected by the RIS 208 using the beam sweeping procedure 302. This is described above.

Referring to FIG. 3B, in a second step 310, the RIS 208 and/or the PU 202 determines UE groups for the UEs. For instance, the PU 202 can determine two UE groups 312 and 314. The first UE group 312 includes the UE 304 and the second UE group 314 includes UEs 306 and 308. For instance, as described above, based on the channel conditions h for each UE, the PU 202 can determine azimuth and elevation angles that correspond to the greatest channel gain. The PU 202 can group the UEs into the different groups (e.g., the UE groups 312 and 314) based on the determinations. The PU 202 can further perform selection of beam forming configurations to serve each of the different groups. In some instances, two more UEs (e.g., the UEs 306 and 308) can be grouped together into a single group. This can occur based on the size of the beam (e.g., the Half Power Beam Width (HPBW)) being wide so that the same beam covers multiple UEs. In this case, from one angular direction (e.g., azimuth and elevation angle), it appears that the power can be maximized for multiple UEs (e.g., both the UE 306 and the UE 308).

Referring to FIGS. 3C and 3D, in a third step 320 and 330, the RIS 208 is configured to communicate with the first UE group 312 and the second UE group 314 based on the determined azimuth and elevation angles and/or the selected beam forming configurations.

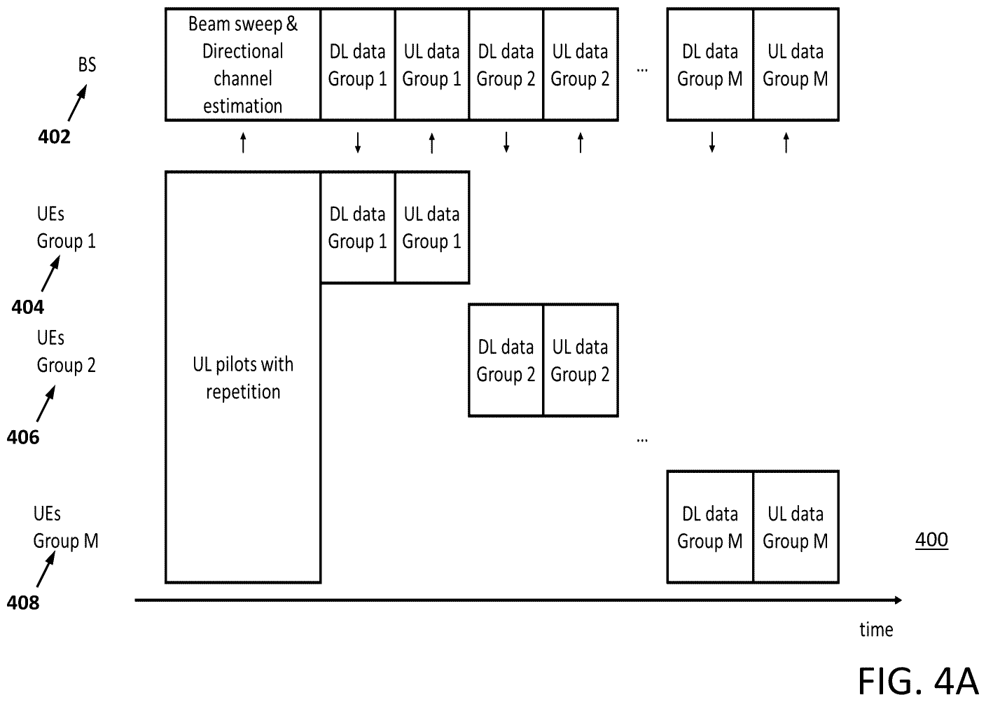

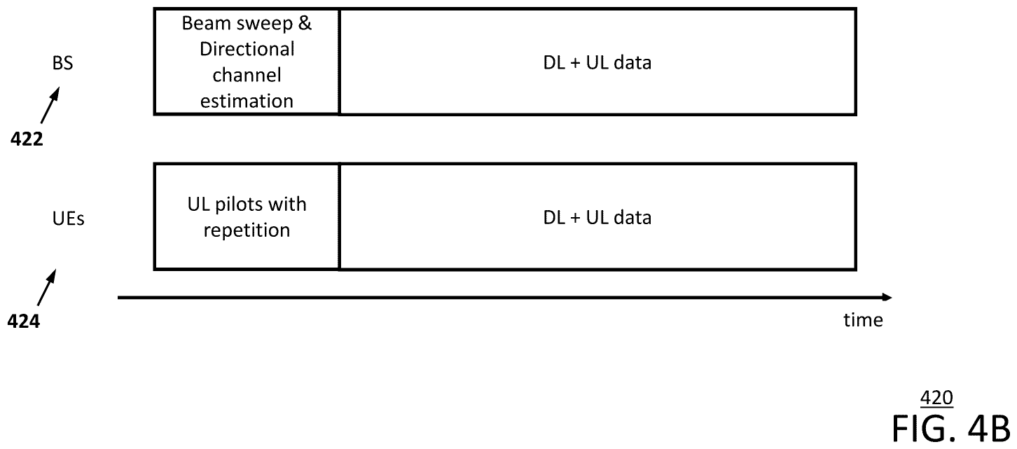

The transmission allocation is now described. For instance, once the channel conditions are estimated, users can be served in a time space division multiple access (TSDMA) approach. For instance, in multi-user MIMO systems, a beam is allocated per each user, and the BS creates simultaneous and independent data streams to the UEs. However, in view of the above, since a single RF chain 204 is employed, it is not possible to simultaneously transmit to multiple UEs. As such, embodiments of the present disclosure can utilize a frame structure depicted on FIGS. 4A and 4B.

FIG. 4A shows a frame structure 400 for the single RIS system according to one or more embodiments of the present disclosure. For instance, FIG. 4A shows a BS frame structure 402, a frame structure 404 for the first group of UEs (e.g., the UE 304 within the first group 312), a frame structure 406 for the second group of UEs (e.g., the UEs 306 and 308 within the second group 314), and a frame structure 408 for group “M” UEs (e.g., an additional number of UE groups that are not shown in FIGS. 3A-3D for brevity). For instance, similar to the FIG. 1, the BS performs channel estimation and the UEs provide UL pilots. However, in contrast to FIG. 1, in FIG. 4A, the BS performs beam sweeping and/or directional channel estimation, which is described above. The UEs (e.g., sources) further provide UL pilots with repetition. Subsequently, different blocks (e.g., resource blocks) of time ranges are used for each of the different groups (e.g., initially, a first resource block can be allocated for communicating the DL data and UL data for the first group 312, then second resource block can be allocated for communicating the DL data and UL data for the second group 314, and so on).

In other words, since a single RF chain 204 is employed, it might not be possible to simultaneously transmit to multiple UEs. To overcome this, embodiments of the present disclosure utilize the frame structure 400. Firstly, the PU 202 processes the selected beams and groups the UEs that are served by the same beam configuration. In this way, the selection of a beam pattern can reach multiple users with a single directional stream. Per each beam in the group, embodiments of the present disclosure can use orthogonal frequency-division multiple access (OFDMA) as an access scheme and allocate time-frequency resources to each user covered by the beam to perform transmission. Based on employing the classic OFDMA access scheme of Long Term Evolution (LTE), multiple users can be served, making it very easy for MNOs to integrate this technology into the existing systems. This operation can be repeated iteratively over all the frames. Note that different ways can be used to multiplex data for multiple users in the same spatial stream. For example, in some embodiments, code division multiple access (CDMA) can be used.

In some examples, in the frame structure 400 (as well as the frame structure 100 in FIG. 1), the pilots are sent by the UEs (e.g., the UEs 304, 306, and 308) while the BS performs beam sweeping. The BS can then measure the power of the signal received from each UE for all the beams in the codebook. Such directional power measurements can provide the necessary information at the PU (e.g., the PU 202) to create an angular power profile per each UE (e.g., an angular power profile for each of the UEs 304, 306, and 308). For instance, the pointing direction of each beam (e.g., the azimuth angle θ and the elevation angle φ) can be associated with the power measured from the pilot signal transmitted by each UE. This can allow for embodiments of the present disclosure to understand the angle of arrival of the signal. From the knowledge of the angle of arrival, embodiments of the present disclosure can retrieve the channel conditions h.

FIG. 4B shows another frame structure 420 for the single RIS system according to one or more embodiments of the present disclosure. For instance, FIG. 4B shows a BS frame structure 422 and collapses the frame structure for the different groups into a frame structure 424. As such, the frame structure 422 includes a beam sweep and directional channel estimation as well as a DL and UL data slot. The frame structure 422 includes the UL pilots with repetition as well as a DL and UL data slot.

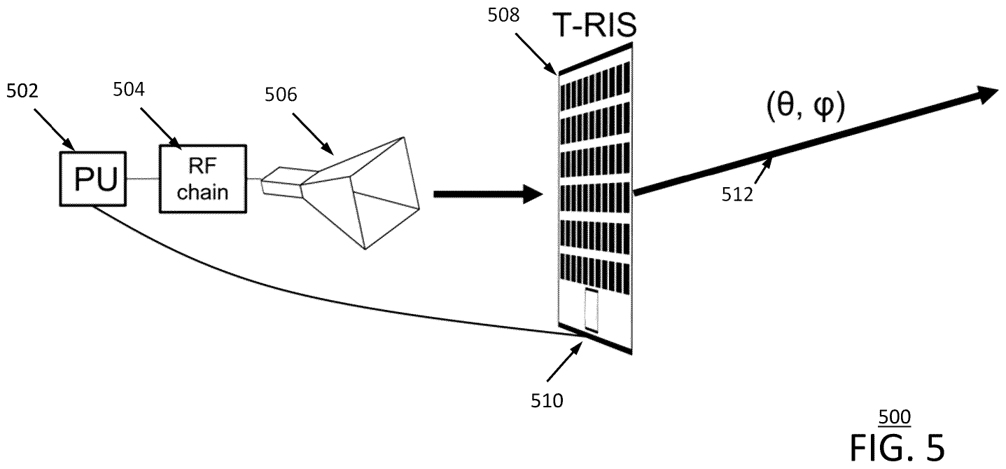

In one or more second embodiments, a single antenna and a single transmissive RIS (T-RIS) are described. For instance, embodiments of the present disclosure can be applied to an emerging typology of RIS that generates beamforming after going through the RIS device, e.g., by generating beams on the face of the surface that is opposite to the one that the wave is impinging on (see e.g., FENG, Chao, et al. RFlens: metasurface-enabled beamforming for IoT communication and sensing. In: Proceedings of the 27th Annual International Conference on Mobile Computing and Networking. 2021. p. 587-600, which is incorporated by reference herein). Different from the classic RIS concept, where the creation of beams is in front of the RIS device while suppressing almost any backward radiation (see e.g., FIG. 2), with T-RIS, the typical beam-shaped radiation pattern is formed behind the RIS. Similar to a normal RIS, the unit cells of the T-RIS can be controlled to manipulate the incoming signal, but now, it is performed while they are passing through the device as shown in FIG. 5.

FIG. 5 illustrates a diagram comprising a single transmissive RIS (T-RIS) system 500 for mimicking MIMO operations according to one or more embodiments of the present disclosure. For instance, the T-RIS system 500 includes a PU 502, an RF chain 504, and an antenna 506. The PU 502, the RF chain 504, and the antenna 506 can be similar to the PU 202, the RF chain 204, and the antenna 206 shown in FIG. 2. The T-RIS system 500 further includes a T-RIS 508 with an MCU 510. The T-RIS 508 transmits a signal 512 that is formed behind the T-RIS.

The process for operating a T-RIS is very similar to the previous embodiment, but an ad-hoc more complex codebook can be considered here. For instance, this can be performed as follows: the T-RIS 508 is sweeping a series of unique single-beam configurations, defined by (θ, φ) while the source (e.g., a UE) is sending pilot signals and the UE replies with the received power P; the information is stored in the PU with 202 the associated angles (θ, φ, P) and power peaks can reveal the position of the UE devices. For instance, the adjective complex can be removed. However, it can be preferable for embodiments of the present disclosure to have beams that are spatially orthogonal to each other (e.g., beams pointing at different directions with minimal overlapping). In addition, the received power P that can be obtained from the UEs can be measured and/or determined is described above.

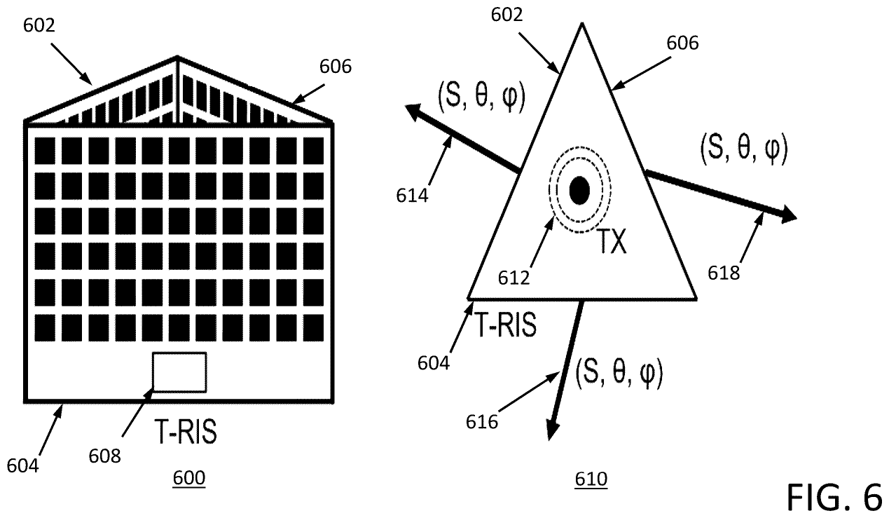

In one or more third embodiments, a single antenna and multiple T-RIS are described. For instance, an orientation of the RIS or the T-RIS can dictate the spatial region where embodiments of the present disclosure can steer the beams. In contrast, by using a single omnidirectional antenna that is surrounded by several T-RIS, almost a 360° power coverage can be realized. This is shown in FIG. 6.

FIG. 6 illustrates a three dimensional (3D) and two dimensional (2D) representation of a multiple T-RIS system for mimicking MIMO operations according to one or more embodiments of the present disclosure. For instance, FIG. 6 shows a 3D representation 600 and a 2D representation 610. The 3D representation 600 includes three T-RIS 602, 604, and 606. The three T-RIS can include an MCU such as the MCU 608 for the T-RIS 604. Furthermore, a single omnidirectional antenna can be included in the interior of the T-RIS 602, 604, and 606. The 2D representation 610 shows the single omnidirectional antenna 612, which can be a transmitter (TX). The three T-RIS 602, 604, and 606 are also shown in the 2D representation 610. In addition, the three signals 614, 616, and 618 are shown to be transmitted outwards to have a substantially 360° power coverage.

The steps utilized to operate this system shown in FIG. 6 are described below. For instance, embodiments of the present disclosure utilize that the T-RIS can be equipped with an absorption mode or a suppressing mechanism for received signals. In this way, embodiments of the present disclosure can guarantee the channel estimation step is performed using only one T-RIS while setting to zero the contributions from the remaining ones. For instance, during channel estimation, one of the T-RIS can be set to the absorption mode and the other two T-RIS can be set to the suppressing mode (e.g., no signals are transmitted outwards). For example, initially, the first T-RIS 602 can be set to the absorption mode and the other two T-RIS 604 and 606 can be set to the suppressing mode. The enabled T-RIS (e.g., the T-RIS 602) sweeps a series of unique single-beam configurations, defined by a triplet (S, θ, φ), where S is the identifier (ID) of the T-RIS or the area sector where it is desired to operate, while the source (e.g., a UE) is sending pilot signals to the T-RIS. The UEs reply with the received power values and the information is stored in the PU as (S, θ, φ, P). This method is repeated for all the T-RIS in the systems. Finally, the PU can choose the configurations for every sector S, depending on the best received power values. The received power values P that can be measured or determined is described above.

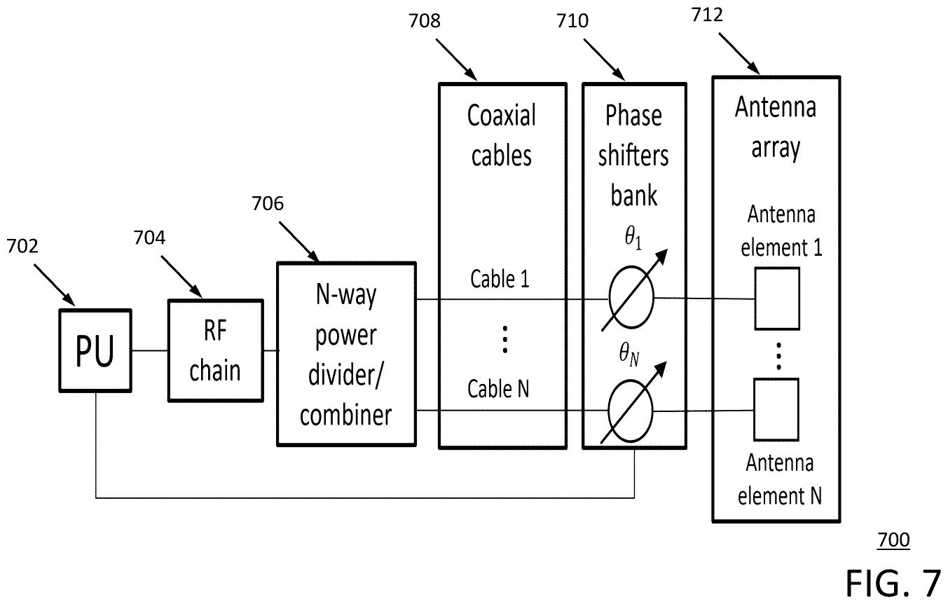

In one or more fourth embodiments, an RF-circuit approach is described. For instance, the signal from the RF-chain to the antenna elements can be also carried through dedicated transmission lines, e.g., coaxial cables and/or RF circuits. This alternative approach is depicted in FIG. 7.

FIG. 7 illustrates a radio frequency (RF)-circuit and antenna array-based system 700 according to one or more embodiments of the present disclosure. For instance, the system 700 includes a PU 702, an RF chain 704, an N-way power divider/combiner 706, coaxial cables 708, phase shifters bank 710, and an antenna array 712.

In particular, in system 700, the T-RIS component is substituted by a traditional antenna array 712. The control of the transmission/receiving direction can come from the shifter banks 710 that control the configuration of each antenna element. In some instances, this configuration shown in system 700 can be equivalent to the one adopted to control the T-RIS, which is described above. The major difference in this embodiment is that the signal from/to the RF-chain 704 reaches the phase shifters 710 and antenna array 712 through an N-way power splitter, that can be implemented using numerous approaches. For instance, the system 700 shows an N-way power divider/combiner 706 that can be used as the N-way power splitter. In other embodiments, Wilkinson power dividers and/or other RF circuits suitable for splitting the transmission signal in N different paths and combining the received signal from N different paths can be used.

In the system 700, the PU 702 can control the Phase shifter bank 710 to select the transmissions direction. The operation described in the first embodiments for performing channel estimation and data transmission/reception can further be used in system 700.

In an embodiment, the present disclosure provides a method for mimicking a multi user MIMO base station with a single or multiple RIS or T-RIS and a single antenna with a single RF-chain. As will be described below, only a classical RIS (e.g., the first embodiment) will be referred to, but one or more of the steps described below are also applicable in the case of the T-RIS (e.g., the second and/or third embodiments) and/or the RF-circuit and antenna array-based system (e.g., the fourth embodiments). For instance, in a first step, the antenna feeder can be positioned in range of the RIS 208 to focus its transmission/reception to/from the surface. In some examples, the antenna feeder can be the antenna 206, which can illuminate the RIS 208. Additionally, and/or alternatively, the RF chain 204 might not be collocated with the antenna feeder and can be connected, for instance, through a coaxial cable to it. In a second step, the antenna (e.g., the antenna 206) with an RF chain 204 can be connected to hardware elements that are compliant with the MIMO standard. In some variations, the hardware compliant with the MIMO standard can be the PU 202, the RF chain 204, and the antenna 206. In some instances, a difference from the MIMO standard can be that typically, multiple branches of the RF chains and antennas are used simultaneously, and connected to a PU 202 that performs the processing. In a third step, a set of orthogonal RIS configurations for performing directional channel sounding can be defined. At a fourth step, a re-designed channel estimation procedure for the system can be performed. For instance, the fourth step can include sub-steps a through f. At step a, the BS can be set to receive pilots. At step b, the RIS 208 can sweep the set of beam patterns of the RIS 208 and receive pilots from the UEs exploiting directionality. At step c, based on the collected channel information, the best beam to communicate with each of the UEs can be selected. At step d, based on the selected beam, the UEs can be grouped into groups that are covered by the same beam. At step e, per each of the UE groups, radio resources can be allocated to communicate with the UEs in the corresponding group. At step f, per each group, downlink and uplink transmissions can be performed to and from the UEs in the group, respectively.

Embodiments of the present disclosure provide for the following improvements and technical advantages over existing technology including: a method to mimic the operation of multi-user MIMO base stations with the aid of an RIS 208 and a single RF-chain antenna, a method to directionally sense pilots from the UEs to obtain spatially orthogonal samples of the channel and combine them to perform MIMO channel estimation with a single RF-chain 204 and an RIS 208, and/or a method for mimicking the multi-user MIMO transmission frame by grouping multiple UEs in the same directional transmission and allocating time-frequency resources in a time space division multiple access fashion with a single RF-chain 204. Based on utilizing embodiments of the present disclosure, advantages can be achieved such as, but not limited to, full integration to standardized systems. For example, embodiments of the present disclosure can be added to existing networks easily and with limited financial investments. For instance, embodiments of the present disclosure can employ hardware with a lower complexity compared to the traditional MIMO technology. In particular, in some examples, embodiments of the present disclosure can boil down the number of RF-chains to a singular one, and can require no RF circuits to bring the signal to all of the antenna elements.

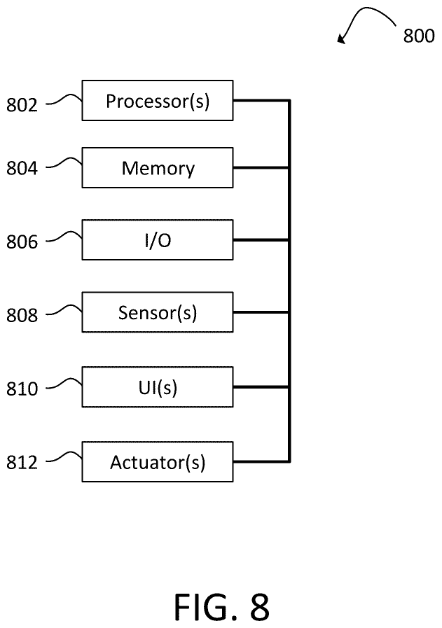

Referring to FIG. 8, a processing system 800 can include one or more processors 802, memory 804, one or more input/output devices 806, one or more sensors 808, one or more user interfaces 810, and one or more actuators 812. Processing system 800 can be representative of each computing system disclosed herein.

Processors 802 can include one or more distinct processors, each having one or more cores. Each of the distinct processors can have the same or different structure. Processors 802 can include one or more central processing units (CPUs), one or more graphics processing units (GPUs), circuitry (e.g., application specific integrated circuits (ASICs)), digital signal processors (DSPs), and the like. Processors 802 can be mounted to a common substrate or to multiple different substrates.

Processors 802 are configured to perform a certain function, method, or operation (e.g., are configured to provide for performance of a function, method, or operation) at least when one of the one or more of the distinct processors is capable of performing operations embodying the function, method, or operation. Processors 802 can perform operations embodying the function, method, or operation by, for example, executing code (e.g., interpreting scripts) stored on memory 804 and/or trafficking data through one or more ASICs. Processors 802, and thus processing system 800, can be configured to perform, automatically, any and all functions, methods, and operations disclosed herein. Therefore, processing system 800 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 800 can be configured to perform task “X”. Processing system 800 is configured to perform a function, method, or operation at least when processors 802 are configured to do the same.

Memory 804 can include volatile memory, non-volatile memory, and any other medium capable of storing data. Each of the volatile memory, non-volatile memory, and any other type of memory can include multiple different memory devices, located at multiple distinct locations and each having a different structure. Memory 804 can include remotely hosted (e.g., cloud) storage.

Examples of memory 804 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 804.

Input-output devices 806 can include any component for trafficking data such as ports, antennas (i.e., transceivers), printed conductive paths, and the like. Input-output devices 806 can enable wired communication via USB®, DisplayPort®, HDMI®, Ethernet, and the like. Input-output devices 806 can enable electronic, optical, magnetic, and holographic, communication with suitable memory 804. Input-output devices 806 can enable wireless communication via WiFi®, Bluetooth®, cellular (e.g., LTE®, CDMA®, GSM®, WiMax®, NFC®), GPS, and the like. Input-output devices 806 can include wired and/or wireless communication pathways.

Sensors 808 can capture physical measurements of environment and report the same to processors 802. User interface 810 can include displays, physical buttons, speakers, microphones, keyboards, and the like. Actuators 812 can enable processors 802 to control mechanical forces.

Processing system 800 can be distributed. For example, some components of processing system 800 can reside in a remote hosted network service (e.g., a cloud computing environment) while other components of processing system 800 can reside in a local computing system. Processing system 800 can have a modular design where certain modules include a plurality of the features/functions shown in FIG. 8. For example, I/O modules can include volatile memory and one or more processors. As another example, individual processor modules can include read-only-memory and/or local caches.

Embodiments of the present disclosure can be implemented as a computer-implemented method, computer system (comprising one or more processors and one or more storage devices) configured to perform the computer-implemented method and/or as a computer program for performing the computer-implemented method. For example, the computer-implemented method can include one or more steps and/or operations discussed above.

Examples may involve or relate to computer programs, including program codes to execute one or more of the mentioned methods when the program is executed on a computer, processor, or other programmable hardware component. As a result, steps, operations, or processes from various methods described above can also be executed by computers, processors, or other programmable hardware components. Examples may additionally cover program storage devices, such as digital data storage media, which are machine-, processor-, or computer-readable and encode and/or contain machine-executable, processor-executable, or computer-executable programs and instructions. These devices may include or be digital storage devices, magnetic storage media like magnetic disks and tapes, hard disk drives, or optically readable digital data storage media, for instance. Other examples encompass computers, processors, control units, field programmable logic arrays (FPLAs), field programmable gate arrays (FPGAs), graphics processing units (GPUs), application-specific integrated circuits (ASICs), integrated circuits (ICs), or system-on-a-chip (SoC) systems that are programmed to carry out the steps of the aforementioned methods. In simpler terms, examples may involve computer programs and storage media comprising computer programs, as well as hardware components like processors and control units, which can be programmed to execute the methods described above.

When certain aspects are mentioned in relation to a device or system, they should also be considered as descriptions of the corresponding methods. For example, a block, component, or functional aspect of the device or system may correspond to a method step or feature of the related method. Therefore, aspects described regarding a method should also be understood as depicting a corresponding element, property, or functional feature of the corresponding device or system. In simpler terms, if something is described in relation to a device or system, it can also be applied to the corresponding method, and vice versa.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications can be made, by those of ordinary skill in the art, within the scope of the following claims, which can include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A computer-implemented method for mimicking a multi-user multiple-input multiple-output (MIMO) base station using a re-designed channel estimation procedure, comprising:
sweeping a set of beam patterns to obtain channel information associated with a plurality of pilot signals from a plurality of user equipment (UEs) based on exploiting directionality;
based on the channel information, selecting a beam to communicate with each of the plurality of UEs;
allocating radio resources to communicate with each of the plurality of UEs based on the selected beam for each of the plurality of UEs; and
performing downlink and uplink transmissions to and from the plurality of UEs based on the allocated radio resources.

2. The computer-implemented method of claim 1, further comprising:
setting a base station (BS) to receive the plurality of pilot signals from the plurality of UEs; and
based on the selected beam for each of the plurality of UEs, grouping the plurality of UEs into one or more groups such that each of the one or more groups are covered by the same selected beam, wherein allocating the radio sources and performing the downlink and uplink transmissions are based on the grouping.

3. The computer-implemented method of claim 1, wherein sweeping the set of beam patterns comprises sweeping the set of beam patterns using a single radio-frequency (RF) chain and a reconfigurable intelligence surface (RIS).

4. The computer-implemented method of claim 3, further comprising:
positioning an antenna in range of the RIS to focus a transmission/reception to/from a surface of the RIS;
connecting the antenna with the RF chain to one or more hardware elements; and
defining a set of orthogonal RIS configurations that are suitable for performing directional channel sounding.

5. The computer-implemented method of claim 3, wherein sweeping the set of beam patterns using the single RF chain and the RIS comprises:
sweeping the set of beam patterns to obtain a plurality of channel conditions for a UE from the plurality of UEs, wherein each beam pattern from the set of beam patterns is associated with an azimuth angle and an elevation angle, and wherein each of the plurality of channel conditions is associated with a beam pattern from the set of beam patterns; and
obtaining the channel information for the UE based on the plurality of channel conditions.

6. The computer-implemented method of claim 5, wherein selecting a beam to communicate with each of the plurality of UEs comprises:
determining a channel condition from the plurality of channel conditions based on comparing absolute values of the plurality of channel conditions;
selecting an azimuth angle and an elevation angle associated with the determined channel condition; and
selecting the beam to communicate with the UE based on the selected azimuth angle and the selected elevation angle.

7. The computer-implemented method of claim 6, wherein selecting the beam to communicate with the UE based on the selected azimuth angle and the selected elevation angle comprises:
selecting the beam based on using a first codebook that was used for sweeping the set of beam patterns, using a second codebook comprising precomputed multi-beam configurations, or generating new beamforming configurations for the RIS.

8. The computer-implemented method of claim 6, further comprising:
grouping the UE into a first group of a plurality of groups based on the selected azimuth angle and the selected elevation angle, wherein the first group comprises a subset of the plurality of UEs that all have the same selected azimuth angle and the same selected elevation angle, and
wherein allocating the radio resources comprises allocating a first resource block for the first group, and wherein the downlink and uplink transmissions for the first group are performed in the first resource block.

9. The computer-implemented method of claim 1, wherein sweeping the set of beam patterns comprises sweeping the set of beam patterns using a system comprising a single radio-frequency (RF) chain and one or more transmissive reconfigurable intelligence surfaces (T-RIS).

10. The computer-implemented method of claim 9, wherein sweeping the set of beam patterns using the single RF chain and the one or more T-RIS comprises:
sweeping a series of unique single-beam configurations to obtain the channel information comprising received powers from the plurality of UEs; and
determining positions of the plurality of UEs based on the received powers, and wherein selecting the beam to communicate with each of the plurality of UEs is based on the determined positions.

11. The computer-implemented method of claim 9, wherein the system comprises a single omnidirectional antenna and three T-RIS that form an exterior of the system, and wherein the single omnidirectional antenna is positioned within an interior formed by the three T-RIS such that the system provides 360° power coverage.

12. The computer-implemented method of claim 1, wherein sweeping the set of beam patterns comprises sweeping the set of beam patterns using a radio frequency (RF) circuit and antenna array-based system comprising an RF chain, an N-way power splitter, coaxial cables, a phase shifters bank, and an antenna array.

13. The computer-implemented method of claim 12, wherein a signal from/to the RF chain reaches the phase shifters bank and the antenna array through the N-way power splitter, and wherein the N-way power splitter is an N-way power divider/combiner.

14. A computer system for mimicking a multi-user multiple-input multiple-output (MIMO) base station using a re-designed channel estimation procedure, the computer system comprising one or more hardware processors, which, alone or in combination, are configured to provide for execution of the following steps:
sweeping a set of beam patterns to obtain channel information associated with a plurality of pilot signals from a plurality of user equipment (UEs) based on exploiting directionality;
based on the channel information, selecting a beam to communicate with each of the plurality of UEs;
allocating radio resources to communicate with each of the plurality of UEs based on the selected beam for each of the plurality of UEs; and
performing downlink and uplink transmissions to and from the plurality of UEs based on the allocated radio resources.

15. A tangible, non-transitory computer-readable medium having instructions thereon which, upon being executed by one or more processors, alone or in combination, provide for execution of a method for mimicking a multi-user multiple-input multiple-output (MIMO) base station using a re-designed channel estimation procedure comprising the following steps:
sweeping a set of beam patterns to obtain channel information associated with a plurality of pilot signals from a plurality of user equipment (UEs) based on exploiting directionality;
based on the channel information, selecting a beam to communicate with each of the plurality of UEs;
allocating radio resources to communicate with each of the plurality of UEs based on the selected beam for each of the plurality of UEs; and
performing downlink and uplink transmissions to and from the plurality of UEs based on the allocated radio resources.
